(19) United States
(12) Patent Application Publication
(10) Pub. No.: US 2014/0158331 A1
(43) Pub. Date: Jun. 12, 2014

(54) Brazing Method For A Heat Exchanger, And Corresponding Tube And Heat Exchanger

(71) Applicants: Laurent Moreau, Reims (FR); Alain Bauerheim, Jonchery sur Vesle (FR); Philippe Metayer, Rozerieulles (FR)

(72) Inventors: Laurent Moreau, Reims (FR); Alain Bauerheim, Jonchery sur Vesle (FR); Philippe Metayer, Rozerieulles (FR)

(21) Appl. No.: 13/995,825

(22) PCT Filed: Dec. 13, 2011
(86) PCT No.: PCT/EP2011/072516

§ 371 Date: Feb. 14, 2014

(30) Foreign Application Priority Data
Dec. 20, 2010 (FR) 1060802

(51) Int. Cl. B23P 15/26; F28D 1/03; B23K 1/00

(52) U.S. Cl. CPC B23P 15/26; B23K 1/00; F28D 1/03
USPC 165/172; 29/890.049; 138/171

(57) ABSTRACT

The invention relates to a brazing method for a tube of an air heater. The method includes the steps of: folding a metal band such as to form at least one tube, providing inside the tube a disturbance insert having a thickness substantially lower than or equal to 150 μm, with the metal band and/or the insert includes a plating layer on at least one surface to be brazed such that the ratio of the volume of the plating layer to the volume to be brazed is either substantially higher than or equal to a predetermined threshold on the basis of the average gap between the insert and the tube, and brazing the tube and the insert.

The invention relates to a brazing method for an air heater, intended in particular for motor vehicles, a tube and an air heater obtained thereby.

The invention is concerned with the field of air heaters, intended in particular for motor vehicles.

Generally, air heaters traditionally consist of a core of tubes and two collector plates traversed by the extremities of the tubes making up the core of tubes and topped by covers of fluid distribution housings. Inserts may also be provided between the tubes of said core in order to improve the thermal exchange.

In the case of heaters intended for assembly by brazing, all the components are assembled and are then brazed in a suitable oven for producing the air heater.

Brazing is carried out with a brazing filler metal, most often produced in the form of plating.

As a general rule, the tubes utilized in brazed air heaters are produced from a metallic material that is not readily oxidizable, such as aluminum or an aluminum alloy.

Brazed air heaters, of which the tubes making up the core are extruded so as to define a plurality of circulation channels for the flow of the fluid, are already known. However, this solution may be relatively costly.

According to another known solution, disturbance inserts or fins, for example corrugated, are arranged inside the tubes making up the core of the air heater in order to increase the thermal exchange surface and thus to improve the performance of the air heater.

Sealing of such tubes consisting of two parts is consequently more difficult to achieve. During brazing, it is necessary to ensure that the brazing is correct at all points of contact between the inserts and the tubes.

In fact, in the event of no brazing being present between a corrugation crest of an insert and the internal surface of a tube, the mechanical strength of the tube is impaired and the tube may burst prematurely under pressure.

The object of the invention is to overcome these disadvantages of the prior art by guaranteeing correct brazing of the surfaces in the interior of the air heater tubes, at a lower cost.

For this purpose, the object of the invention is a brazing method for an air heater for the exchange of heat between at least a first and a second fluid, said heater comprising a core of tubes for the flow of said first fluid, characterized in that it comprises the following steps:
folding a metal band such as to form at least one tube,
providing inside said tube a disturbance insert having a thickness substantially lower than or equal to 150 μm, and
said metal band and/or said insert consists of a plating layer on at least one surface to be brazed such that the ratio of the volume of the plating layer to the volume to be brazed is substantially higher or equal to a predetermined threshold on the basis of the average gap between said insert and said tube, and
brazing said tube and said insert.

Said method may also consist of one or more of the following characteristics, taken separately or in combination:
said threshold is substantially in the order of 1.5 for an average gap in the order of 0.05 mm between a tube and an insert;
said threshold is substantially in the order of 1.75 for an average gap in the order of 0.05 mm between a tube and an insert;
said insert consists of a plating layer;
the internal surface of said tube consists of a plating layer;
said method comprises the following steps:
   preparing a plurality of tubes consisting of a plating layer on at least one surface to be brazed to the exterior of said tubes;
   stacking a plurality of tubes by interposing spoilers for disturbing the flow of said second fluid between said tubes, and,
a plating layer is arranged on the external surface of said tubes;
a plating layer is arranged on the internal surface and on the external surface of said tubes.

The invention also relates to an air heater tube formed by folding a metal band, characterized in that it is brazed according to a brazing method as defined above.

According to one embodiment, said metal band consists of aluminum.

The invention further relates to an air heater, intended in particular for a motor vehicle, comprising a core of tubes, characterized in that it is brazed according to a brazing method as defined above.

Other characteristics and advantages of the invention will become clearer from reading the following description, given by way of illustrative example and without limitation, and from the accompanying drawings, in which:

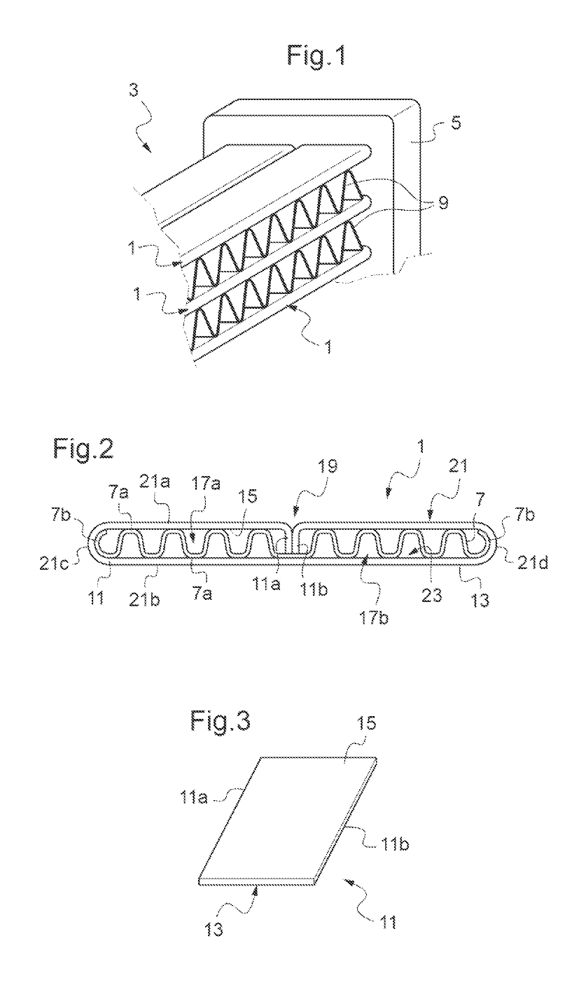

FIG. 1 represents an air heater partially and schematically,

FIG. 2 is a view in cross section of a tube of the heater in FIG. 1, and

FIG. 3 illustrates schematically a metal band used for the formation of the tube in FIG. 2.

In these figures, the substantially identical elements bear the same references.

The invention relates to a brazing method for tubes 1 suitable for use in brazed air heaters.

Air conditioning condensers for motor vehicles may be mentioned as an example of an air heater. In this case, the thermal exchange takes place between a first fluid such as a refrigerant, and a second coolant such as glycolated water.

As partially illustrated in FIG. 1, an air heater 3 traditionally comprises a plurality of longitudinal tubes 1 mounted between two distribution housings, inside which a first fluid circulates, by means of collector plates 5 (represented partially and schematically) positioned transversely in relation to the tubes 1 and exhibiting orifices (not represented here) to receive the extremities of these tubes 1.

Disturbance inserts or fins 7 (FIG. 2), for example of substantially corrugated form, are arranged inside the tubes 1 in such a way as to disturb the flow of the first fluid in the tubes 1 by increasing the exchange surface. These inserts 7 are, for example, brazed to the tubes 1 at the level of the peaks 7a of their corrugations and, for example, at the level of the extremities 7b of the inserts 7.

The disturbance produced by the presence of said inserts 7 in the tubes 1 facilitates the thermal exchanges between the two fluids.

These inserts 7 are produced with a small thickness, that is to say substantially lower than 150 μm, in order to reduce the costs. According to a preferred embodiment, the inserts 7 possess a thickness in the order of 100 μm.

These inserts 7 are well known to a person skilled in the art and are not described in greater detail in this document.

The tubes 1 may be separated one from the other by means of spoilers 9 (FIG. 1), for example corrugated spoilers, through which the second fluid passes in order for a thermal exchange to take place with the first fluid. These spoilers 9 in the illustrated example are arranged transversely in relation to the longitudinal axis of the tubes 1.

Reference is now made to FIG. 2, which illustrates a cross-sectional view of a tube 1 of such a heater 3.

The tube 1 is produced from a folded and brazed metal band 11. This is referred to as a “folded tube”.

Said metal band 11 (FIG. 3) is preferably made of aluminum or an aluminum alloy.

The metal band 11 is of generally rectangular shape, for example, and comprises a first face known as the external face 13 and a second face known as the internal face 15 parallel to the external face 13 and opposite thereto. The terms “internal” and “external” are defined in relation to the interior and to the exterior of the folded tube 1. The metal band 11 forming the tube is provided with a plating layer on at least one surface for brazing. In other words, a metal band 11 consisting of one plating layer arranged at least at the level of the zones for brazing is proposed.

One embodiment proposes that the surface to be brazed is intended to be situated inside said tube once the latter has been assembled.

According to the example illustrated in FIG. 2, the formed tube 1 exhibits a cross section substantially in the form of a “B”. Other cross sections may be proposed, of course.

The “B”-shaped cross section of the illustrated tube 1 exhibits two juxtaposed parallel channels 17a and 17b for the circulation of fluid and separated by a separation 19 forming a brace.

In order to form such a tube 1, the metal band 11 is folded back over itself so as to form the envelope of the two juxtaposed parallel channels 17a and 17b. More specifically, the metal band 11 is folded so that its internal face 15 defines the two channels 17a, 17b.

The separation 19 is produced, for example, by folding substantially through 90° two opposite edges 11a and 11b of the metal band 11, for example the longitudinal edges of the band 11. These folded edges 11a, 11b are then folded back-to-back one against the other in order jointly to form the separation 19. The external face 13 at the level of the edge 11a thus faces the external face 13 at the level of the opposite edge 11b.

Thus, once the band 11 has been folded, the external face 13 of the band 11 forms the external surface 21 of the tube 1 formed in this way, and the internal face 15 of the band 11 forms the internal surface 23 of the tube 1 formed in this way.

In addition, the external surface 21 of the folded tube 1 exhibits two large opposing external faces 21a, 21b, which are connected together by two small lateral faces 21c and 21d, for example being substantially inwardly curved.

The tubes 1 obtained thereby can then be assembled with the inserts 7 and the corrugated spoilers 9, in order to form a core which can be brazed.

In fact, the various metallic constituent parts to be joined together by such an air heater 3 are first assembled, and their joining is then assured by their passage into a brazing oven.

It is thus possible to perform brazing, in a single operation, of an exchange core consisting of a large number of tubes 1, of disturbance fins 7 inside the tubes 1, and possibly of spoilers 9 positioned in each case between two successive tubes 1.

More precisely, during assembly:
the tubes 1 are formed by folding a metal band 11;
the inserts 7 are arranged inside the tubes 1;
the tubes 1 are engaged in associated orifices of the collector plates 5, mounted on which are the distribution housings at the extremity of the air heater;
spoilers 9 may be mounted between the stacked tubes 1; and
the whole is finally assembled by brazing.

Brazing takes place traditionally by utilizing a brazing filler metal, and in order to improve the brazing method it is also possible to utilize a brazing flux, for example applied in the form of a paste under controlled conditions, said paste dissolving the layer of oxide formed naturally on the surface of the parts to be assembled and wetting the parts to be brazed in order, in this way, to permit the brazing filler metal to spread over the contact surfaces.

The brazing filler metal is most often formed by a layer of plating. For the purpose of plating, the filler metal exhibits a fusion temperature lower than that of the metal forming the body of the tube 1, for example aluminum. Here, the layer of plating is placed directly on the metal band 11 used for making the tube.

As far as the brazing of the surfaces on the exterior of the tubes 1 is concerned, that is to say between the external surfaces 21 of the tubes 1 and the interleaved spoilers 9, it is possible for one plating layer arranged on the metal band 11 to be applied in such a way that said layer is arranged on the external surfaces 21 of the tubes 1 and/or on the spoilers 9.

However, the configuration according to which no plating layer is present on the external surfaces 21 of the tubes 1 consequently requires plated spoilers 9, which involves an additional cost. As a consequence, the plating layer is preferentially arranged on the external surface 21 of each tube 21.

As far as the brazing of the surfaces inside the tube 1 is concerned, that is to say the brazing of the peaks 7a of the inserts 7 and, for example, of the extremities 7b of the inserts 7 on the internal surface 23 of the tube 1, the plating layer may be arranged uniquely on the surfaces to be brazed of the inserts 7 or, as a variant, both on the inserts 7 and on the internal surface 23 of each tube 1.

In the configuration according to which no plating layer is present on the internal surfaces 23 of the tubes 1, the plated inserts 7 possess a greater thickness, which increases the cost. As a consequence, the plating layer is preferentially similarly arranged on the internal surface 23 of each tube 1.

The internal surface 23 as well as the external surface 21 of the tube 1 are thus plated advantageously in the course of the brazing method.

Furthermore, the thickness of the plating layer is standardized. In fact, the limit of the thickness of the plating layer on the inserts 7 is in the order of 10 to 15% of the material thickness of the insert. Likewise, the thickness of the plating layer on the internal surface 23 of the tube 1 is defined by a standard, and the limit is in the order of 12.5 to 15% of the material thickness of the tube 1.

In order to guarantee correct brazing in the interior of a tube 1, it is necessary to have a sufficient volume of plating in relation to the volume to be brazed inside the tube 1, this ratio being referred to as BCR from the English “Brazing Confident Ration” (see equation (1)):

$$BCR = \frac{Volume of plating}{Volume to be brazed} \qquad ( 1 )$$

If the ratio is insufficient and is therefore lower than a predetermined threshold, the quantity of plating in relation to the zone to be brazed will be insufficient to guarantee brazing of all the folds of the insert 7 on the internal surface 23 of the tube 1.

By way of example, for the purpose of determining the volume to be brazed, the total length to be brazed is defined and this is then multiplied by the average gap between the internal surface 23 of the tube 1 and the surface of the insert 7 to be brazed. This average gap is in the order of 0.05 mm, for example.

The applicant has established that, for such a gap in the order of 0.05 mm, correct brazing is obtained with a BCR ratio higher or equal to 1.5, and in particular higher or equal to 1.75.

In fact, for a BCR ratio in the order of 1.4 with an average gap in the order of 0.05 mm between a tube 1 and an insert 7, the applicant has established that all the folds of the insert 7 are not correctly brazed to the internal surface 23 of the tube 1. The mechanical strength of the tube 1 is impaired, however, when a fold is not brazed to the internal surface 23 of a tube 1.

A BCR ratio higher or equal to a threshold of 1.75 for an average gap of 0.05 between a tubes 1 and an insert 7 makes it possible to guarantee correct brazing of the folds of the insert 7 on the internal surface 23 of the tube 1, for inserts 7 having a relatively small thickness, for example lower than 150 μm or in the order of 100 μm, as previously mentioned.

Thus, the brazing method provides for the arrangement of a plating layer either on the insert 7 at the level of the peaks 7a and possibly of the extremities 7b, and/or on the internal surface 23 of the tube 1, by making sure that the BCR ratio of the volume of the plating layer to the volume to be brazed is higher than the predetermined threshold on the basis of the average gap between the tube 1 and the peaks 7a.

Furthermore, it should be noted that, after brazing, it is possible to determine the volume of plating utilized for the brazing on the basis of the residual quantity of plating inside the tubes 1 and on the basis of the quantity of plating present at the level of the joints between the insert 7 and the internal surface 23 of a tube 1.

An air heater 3 exhibiting tubes 1 referred to as folded tubes and of which the disturbance fins 7 are relatively fine, while guaranteeing a contact between all the folds of the disturbance fins 7 on the internal surfaces 23 of the tubes 1, is thus obtained with such a method at a low cost.

1. A brazing method for an air heater for the exchange of heat between at least a first and a second fluid, the heater comprising a core of tubes for the flow of the first fluid, said method comprising the steps of:
folding a metal band such as to form at least one tube,
providing inside the tube a disturbance insert having a thickness substantially lower than or equal to 150 μm, and
the metal band and/or the insert including a plating layer on at least one surface to be brazed such that the ratio of the volume of the plating layer to the volume to be brazed is substantially higher or equal to a predetermined threshold on the basis of the average gap between the insert and the tube, and
brazing the tube and the insert.

2. The method as claimed in claim 1, wherein the threshold is substantially in the order of 1.5 for an average gap in the order of 0.05 mm between the tube and the insert.

3. The method as claimed in claim 1, wherein the threshold is substantially in the order of 1.75 for an average gap in the order of 0.05 mm between the tube and the insert.

4. The method as claimed in claim 1, wherein a plating layer is arranged on the insert.

5. The method as claimed in claim 1, wherein a plating layer is arranged on an internal surface of the tube.

6. The method as claimed in claim 1, wherein said method further comprises the steps of:
preparing a plurality of tubes including of a plating layer on at least one surface to be brazed on an exterior of the tubes; and
stacking a plurality of tubes by interposing spoilers for disturbing the flow of the second fluid between tubes.

7. The method as claimed in claim 6, wherein a plating layer is arranged on the external surface of the tubes.

8. The method as claimed in claim 1, wherein a plating layer is arranged on the internal surface and on the external surface of the tubes.

9. An air heater tube formed by folding a metal band, wherein the air heater tube is brazed according to a brazing method corresponding to claim 1.

10. The tube as claimed in claim 9, wherein the metal band comprises of aluminum.

11. An air heater for a motor vehicle, comprising a core of tubes wherein the air heater is brazed according to a brazing method corresponding to claim 1.

12. The method as claimed in claim 2, wherein a plating layer is arranged on the insert.

13. The method as claimed in claim 3, wherein a plating layer is arranged on the insert.

14. The method as claimed in claim 2, wherein a plating layer is arranged on an internal surface of the tube.

15. The method as claimed in claim 3, wherein a plating layer is arranged on an internal surface of the tube.

16. The method as claimed in claim 4, wherein a plating layer is arranged on an internal surface of the tube.
